(19) United States
(12) Patent Application Publication
(10) Pub. No.: US 2010/0079349 A1
(43) Pub. Date: Apr. 1, 2010

(54) PARASITIC ANTENNA

(76) Inventors: Hanyang Wang, Abingdon (GB); Ming Zheng, Farnborough (GB)

Correspondence Address: HARRINGTON & SMITH, 4 RESEARCH DRIVE, Suite 202, SHELTON, CT, 06484-6212, US

(21) Appl. No.: 12/312,450

(22) PCT Filed: Nov. 13, 2006
(86) PCT No.: PCT/IB2006/003260

§ 371 Date: Nov. 23, 2009

(51) Int. Cl. H01Q 19/02; H01Q 1/36

(52) U.S. Cl. 343/833; 343/700 MS

(57) ABSTRACT

A parasitic antenna including a first portion having a first length; a second portion having a second length, different to the first length; and wherein the second portion includes a folded part which orients a part of the second portion substantially towards the first portion.

### FIELD OF THE INVENTION

Embodiments of the present invention relate to a parasitic antenna. In particular, they relate to a parasitic antenna for a mobile cellular telephone.

### BACKGROUND TO THE INVENTION

In recent years, it has become desirable for cellular telephones to be able to communicate over multiple bands of the radio portion of the electromagnetic spectrum. This has arisen because different countries tend to use different frequency bands for cellular networks. For example, in the USA, GSM operates at frequency bands centred at 850 MHz and 1900 MHz, whereas in other countries around the World, GSM operates at frequency bands centred at 900 MHz and 1800 MHz. Even in a single country, different services (using different protocols) may be provided at different radio frequency bands, for example, PCS is at 1900 MHz whereas PCN is at 1800 MHz. Additionally, in a dual-mode handset, both GSM and UMTS (Universal Mobile Telecommunications Systems) are implemented, which can include GSM 850/900/1800/1900 and WCDMA (Wideband Code Division Multiple Access) 850/900/1700/1900/2100. Consequently, cellular telephones require multi-band, multi-mode antenna arrangements that can allow them to communicate over multiple bands of the radio portion of the electromagnetic spectrum using different protocols.

One problem associated with multi-band, multi-mode antenna arrangements is that they may occupy a relatively large volume within the cellular telephone. For example, if a switch is used in combination with a PIFA, it increases the volume required by the antenna arrangement. Additionally, the switch may increase the cost of the antenna arrangement.

Therefore, it would be desirable to provide an alternative antenna arrangement for a mobile cellular telephone.

### BRIEF DESCRIPTION OF THE INVENTION

According to one embodiment of the present invention there is provided a parasitic antenna comprising: a first portion having a first length; a second portion having a second length, different to the first length; and wherein the second portion includes a folded part which orients a part of the second portion substantially towards the first portion.

The parasitic antenna may be substantially planar. The folded part of the second portion may be folded in the plane of the parasitic antenna. The folded part of the second portion may include a plurality of bends in the plane of the parasitic antenna. Each bend of the plurality of bends may be positioned and angled to determine a planar profile for the parasitic antenna. Each bend of the plurality of bends may be positioned and angled to reduce the planar dimensions of the parasitic antenna.

The parasitic antenna may further comprise a ground point. The folded part may orient the part of the second portion towards the ground point. The first portion may be connected to the ground point. The second portion may be connected to the ground point. The first portion and the second portion may extend in substantially opposite directions from the ground point.

The parasitic antenna may further comprise a third portion. The third portion may be connected to the ground point, the first portion and the second portion. The first portion and the second portion may be connected to the ground point via the third portion.

The first portion may be operable in a first frequency band. The second portion may be operable in a second frequency band, different to the first frequency band.

According to another embodiment of the present invention there is provided a method for forming a parasitic antenna, comprising: providing a first portion having a first length; providing a second portion having a second length, different to the first length; and arranging the second portion to include a folded part which orients a part of the second portion substantially towards the first portion.

The parasitic antenna may be substantially planar. The folded part of the second portion may be folded in the plane of the parasitic antenna. The method may also comprise arranging the folded part of the second portion to include a plurality of bends in the plane of the parasitic antenna. The method may further comprise selecting the position and angle of each bend of the plurality of bends to determine a planar profile for the parasitic antenna. The selection of the position and angle for each bend of the plurality of bends may be for reducing the planar dimensions of the parasitic antenna.

The method may further comprise providing a ground point. The method may comprise arranging the folded part so that the part of the second portion is oriented towards the ground point.

The method may comprise connecting the first portion to the ground point. The method may comprise connecting the second portion to the ground point. The method may comprise arranging the first portion and the second portion so that they extend in substantially opposite directions from the ground point.

The method may comprise providing a third portion, connected to the ground point, the first portion and the second portion. The first portion and the second portion may be connected to the ground point via the third portion.

The first portion may be operable in a first frequency band and the second portion may be operable in a second frequency band, different to the first frequency band.

According to another embodiment of the present invention there is provided an antenna arrangement comprising a parasitic antenna as described in the preceding paragraphs; and an antenna, connected to a feed point, which is arranged to electromagnetically couple with the parasitic antenna.

According to a further embodiment of the present invention there is provided an apparatus comprising a parasitic antenna as described in the preceding paragraphs.

According to another embodiment of the present invention there is provided an apparatus comprising an antenna arrangement as described in the preceding paragraphs.

According to a further embodiment of the present invention there is provided a parasitic antenna comprising: a first portion having a first length; a second portion having a second length, different to the first length, and a plurality of bends; and wherein the parasitic antenna is substantially planar, and the plurality of bends are in the plane of the parasitic antenna and are positioned and angled to determine the planar profile of the parasitic antenna.

The plurality of bends may be positioned and angled to reduce the planar dimensions of the parasitic antenna.

### BRIEF DESCRIPTION OF THE DRAWINGS

For a better understanding of the present invention reference will now be made by way of example only to the accompanying drawings in which:

FIG. 1 illustrates a schematic diagram of an apparatus according to one embodiment of the present invention;

FIG. 2 illustrates a schematic diagram of an antenna arrangement according to a first embodiment of the present invention;

FIG. 3 illustrates a schematic diagram of an antenna arrangement according to a second embodiment of the present invention;

FIG. 4 illustrates a schematic diagram of an antenna arrangement according to a third embodiment of the present invention; and

FIG. 5 illustrates a schematic diagram of an antenna arrangement according to a fourth embodiment of the present invention.

### DETAILED DESCRIPTION OF EMBODIMENTS OF THE INVENTION

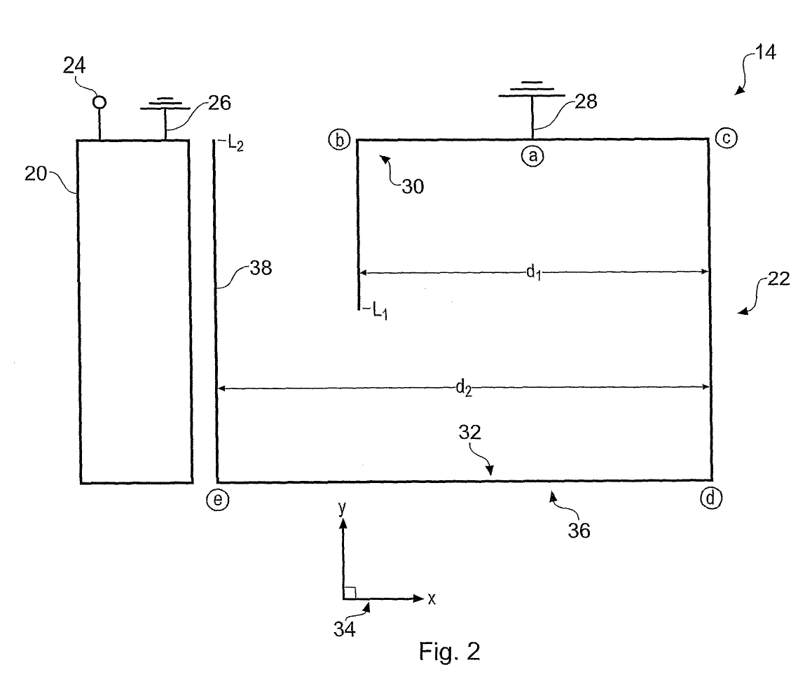

FIGS. 2 to 5 illustrate a parasitic antenna 22 comprising: a first portion 30 having a first length (L₁); a second portion 32 having a second length (L₂), different to the first length; and wherein the second portion 32 includes a folded part 36 which orients a part 38 of the second portion 32 substantially towards the first portion 30.

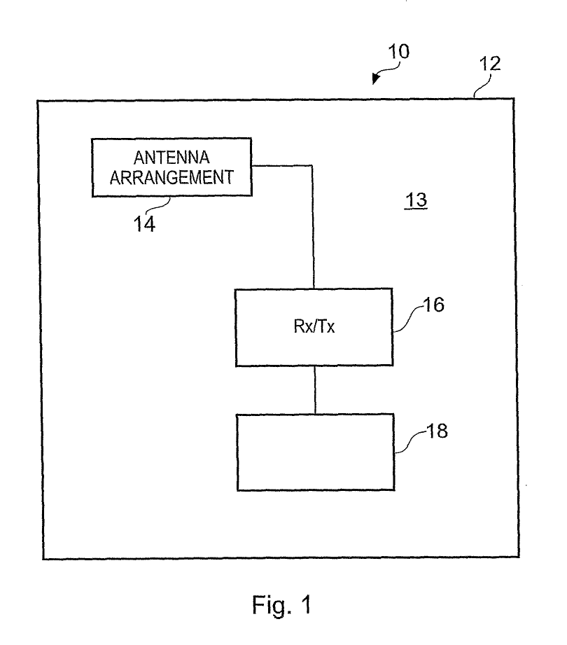

In more detail, FIG. 1 illustrates a schematic diagram of an apparatus 10 such as a mobile cellular telephone, laptop computer, other radio communication device, portable electronic device or module for such devices. The apparatus 10 comprises a housing 12 which defines a cavity 13, an antenna arrangement 14, radio transceiver circuitry 16 and functional circuitry 18. The antenna arrangement 14 is connected to the radio transceiver circuitry 16, which is in turn connected to the functional circuitry 18. In the embodiment where the apparatus 10 is a mobile cellular telephone, the functional circuitry 18 includes a processor, a memory and input/output devices such as a microphone, a loudspeaker and a display. Typically the electronic components that provide the radio transceiver circuitry 16 and functional circuitry 18 are interconnected via a printed wiring board (PWB, not illustrated in the figure) which may serve as a ground plane for the antenna arrangement 14.

FIG. 2 illustrates a first embodiment of an antenna arrangement 14 which includes an antenna 20 and a parasitic antenna 22. The antenna 20 is fed via a feed point 24 and is also connected to a ground point 26. The antenna 20 may be any antenna which is suitable for an antenna arrangement within an apparatus such as a mobile cellular telephone etc. . . . For example, the antenna 20 may be a planar inverted F antenna (PIFA), an inverted F antenna (IFA), a monopole antenna or a loop antenna.

Parasitic antennas are antennas which are only connected electrically to a ground point and which comprise at least one parasitic element (i.e. an element with no galvanic RF feed point).

In the embodiments which are described in the following paragraphs, the antenna 20 has a resonant mode which enables it to transmit and receive electromagnetic signals within the GSM 850 frequency band (centred at 850 MHz) and another resonant mode which enables it to transmit and receive electromagnetic signals within the GSM 1800 frequency band (centred at 1800 MHz). However, it should be appreciated that the antenna 20 may be operable in different frequency bands in other embodiments and using different protocols. For example, the different frequency bands and protocols may include US-GSM 850 (824-894 MHz); EGSM 900 (880-960 MHz); PCN/DCS1800 (1710-1880 MHz); US-WCDMA1900 (1850-1990) band; WCDMA21000 band (Tx: 1920-19801 Rx: 2110-2180); and PCS1900 (1850-1990 MHz). Embodiments of the invention are not limited to the above list of frequency bands and can be applied to other current or future radio communication frequency bands.

The parasitic antenna 22 lies in a flat geometric plane and is located above, and oriented parallel to, the printed wiring board. The parasitic antenna 22 is also connected to a ground point 28 and is arranged to be electromagnetically fed by the antenna 20. The parasitic antenna 22 includes a first portion 30 (extending from the ground point 28) having a first length (L₁) and a second portion 32 (extending from the ground point 28) having a second length (L₂), which is different to the first length. The first portion 30 and the second portion 32 have resonant modes at L₁=λ/4 and L₂=λ/4 respectively (if one assumes that physical length and electrical length are the same). In order for the parasitic antenna 22 to be electromagnetically fed by the antenna 20, it is necessary to select the lengths L₁ and L₂ so that the electrical lengths are such that the portions 30, 32 resonate in frequency bands which are similar to those of the antenna 20. Consequently, in this embodiment, the length L₁ of the first portion 30 is selected so that the first portion 30 resonates at the frequency band GSM 1900 and electromagnetically couples with the resonant mode in the antenna 20 which is operable in the GSM 1800 band. The length L₂ of the second portion 32 is selected so that the second portion 32 resonates at the frequency band GSM 900 and electromagnetically couples with the resonant mode of the antenna 20 which is operable in the GSM 850 band.

in another embodiment, the length L₁ of the first portion 30 is selected so that the first portion 30 resonates at the frequency band GSM 1800 and electromagnetically couples with the resonant mode in the antenna 20 which is operable in the GSM 1900 band. The length L₂ of the second portion 32 is selected so that the second portion 32 resonates at the frequency band GSM 850 and electromagnetically couples with the resonant mode of the antenna 20 which is operable in the GSM 900 band.

In one embodiment, the first portion 30 resonates at the frequency band WCDMA2100 in addition to the frequency band GSM1900. In this embodiment, the antenna arrangement 14 is a penta-band antenna arrangement and resonates at the frequency bands GSM850/900/1800/1900 and WCDMA 2100.

A Cartesian co-ordinate system 34 is provided in FIG. 2 which includes an X axis and a Y axis which are in the same plane as one another. The X axis is orthogonal to the Y axis. The parasitic antenna 22 is displaced from the antenna 20 in the +X direction and includes a plurality of right-angled bends in the plane of the parasitic antenna 22. The plane of the antenna 20, the parasitic antenna 22 and the plane of the co-ordinate system 34 are parallel.

At a point (a) (co-located with the ground point 28), the first portion 30 extends from the ground point 28 in the −X direction. At a point (b), the first portion 30 makes a right-angled left hand bend and then extends in the −Y direction until its end.

At the point (a), the second portion 32 extends from the ground point 28 in the +X direction. At a point (c), the second portion 32 makes a right-angled right hand bend and then extends in the −Y direction until a point (d). It should be noted that the second portion 32 extends for a greater distance between points (c) and (d) than the first portion 30 between point (b) and its end. At point (d), the second portion 32 makes a right-angled right hand bend and then extends in the −X direction until point (e). It should be noted that the distance between points (d) and (e) is greater than the distance between points (b) and (c). At point (e), the second portion 32 makes a right-angled right hand bend and then extends in the +y direction until its end which is, in this example, at substantially the same position on the Y axis as the ground point 28 at point (a).

It should be appreciated from the above description and from FIG. 2, that the second portion 32 includes a folded part 36 which orients a part 38 of the second portion (between point (e) and the end of the second portion) substantially towards the first portion 30. It also orients the part 38 towards the ground point 28 at point (a). The folded part 36 at least partially determines the planar profile of the parasitic antenna (i.e. the shape and configuration of the parasitic antenna 22 in the plane).

The positioning and angles of the bends of the second portion 32 (which make up the folded part 36) can be selected in order to reduce the planar dimensions of the parasitic antenna 22. This means that the length of the parasitic antenna 22 along the Y axis and the width of the parasitic antenna 22 along the X axis may be optimised so that both are as small as possible. During this selection, electromagnetic coupling between parts of the parasitic antenna 22 should also be taken into account so that the first portion 30 and the second portion 32 may operate efficiently.

As will be appreciated by a person skilled in the art, the magnetic field from the first portion 30 and from the second portion 32 will be at its maximum near the ground point 28. In order to reduce this magnetic coupling in this embodiment, the first portion 30 between points (a) and (b) is oriented in an opposite direction to the second portion 32 between points (a) and (c). This configuration helps to maximise the distance between the first portion 30 and the second portion 32 near the ground point and hence reduce magnetic coupling.

In this embodiment, the positioning and angles of the bends in the second portion 32 result in the distance d₁ between points (b) and (c) being less than the distance d₂ between the points (d) and (e). Since the distance d₂ is relatively large and the second portion 32 effectively defines the perimeter of the parasitic antenna 22, the second portion 32 operates efficiently at its resonant mode because there is reduced electromagnetic coupling between respective parts of the second portion 32 and between the first portion 30 and the second portion 32. However, since the distance d₁ is relatively small, the first portion 30 electromagnetically couples with the second portion 32 along its length L₁ and consequently, it does not operate as efficiently as the second portion 32.

Embodiments of the present invention provide an advantage in that the antenna arrangement 14 is operable in at least four different frequency bands (GSM 850, 900, 1800 and 1900) (also WCDMA 2100 when the antenna arrangement 14 is a penta band antenna arrangement as discussed above) but is also relatively compact and may require less space within an apparatus such as a mobile cellular telephone. This may consequently help to reduce the overall size of the apparatus.

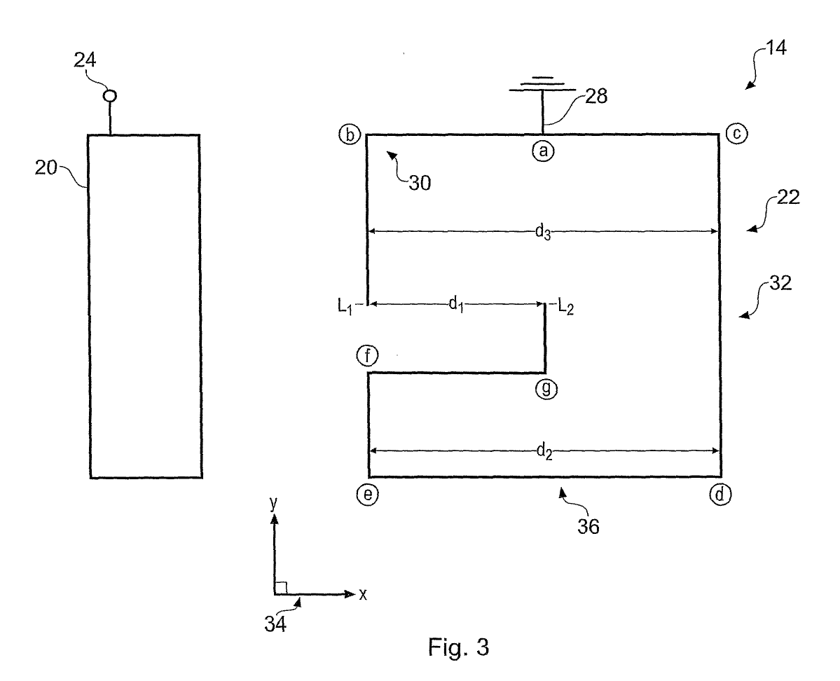

FIG. 3 illustrates a second embodiment of an antenna arrangement 14 which includes an antenna 20 and a parasitic antenna 22. In this embodiment, the antenna 20 is a monopole antenna and is consequently only connected to the feed point 24. The first portion 30 of the parasitic antenna 22 is similar to the first portion 30 illustrated in FIG. 2 and will consequently not be described in detail. The second portion 32 of the parasitic antenna 22 is similar to the second portion 32 illustrated in FIG. 2. The difference between the second portion 32 of FIG. 3 and the second portion of FIG. 2 will now be described.

In the embodiment illustrated in FIG. 3, the second portion 32 extends from the point (e) in the +Y direction to a point (f) where it makes a right-angled right hand bend. The second portion 32 then extends in the +X direction until point (g) where it makes a right-angled left hand bend and then extends in the +Y direction until its end point. The distance between points (f) and (g) is the same as the distance between points (a) and (b).

In this embodiment, the positioning and angles of the bends in the second portion 32 provide a folded part 36 which orients a part 38 of the second portion 32 towards the first portion 30 and towards the ground point 28 at point (a). In this embodiment, the first portion 30 is more efficient when operating at its resonant mode than the first portion 30 illustrated in FIG. 2. This is because although the distance d₁ between its end point and the end point of the second portion 32 is relatively small, the distance d₃ between the remainder of the first portion 30 and the second portion 32 is relatively large and consequently, electromagnetic coupling between the first portion 30 and the second portion 32 is reduced. The second portion 32 is less efficient at its resonant mode than the second portion 32 illustrated in FIG. 2 because the part between point (g) and its end point is positioned closer to the part between points (c) and (d). Consequently, electromagnetically coupling between these parts is increased which reduces the efficiency of the second portion 32.

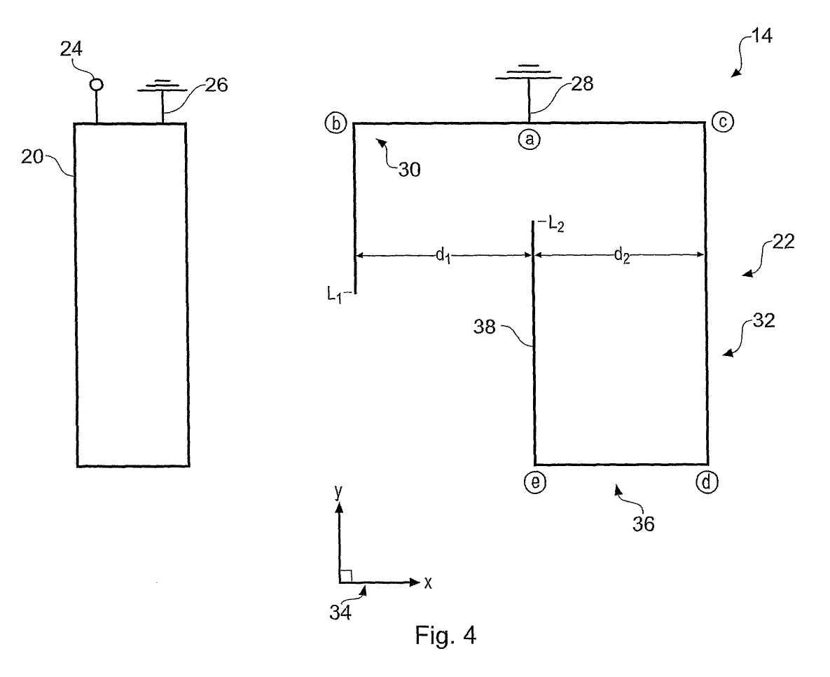

FIG. 4 illustrates a third embodiment of an antenna arrangement 14 which includes an antenna 20 and a parasitic antenna 22. As discussed above with reference to FIG. 2, the antenna 20 may be any antenna which is suitable for an antenna arrangement within an apparatus such as a mobile cellular telephone etc. . . . For example, the antenna 20 may be a planar inverted F antenna (PIFA), an inverted F antenna (IFA), a monopole antenna or a loop antenna.

The first portion 30 of the parasitic antenna 22 is similar to the first portion 30 illustrated in FIG. 2 and will consequently not be described in detail. The second portion 32 of the parasitic antenna 22 is similar to the second portion 32 illustrated in FIG. 2. The difference between the second portion 32 of FIG. 4 and the second portion 32 of FIG. 2 will now be described.

In FIG. 4, the distance between points (d) and (e) of the second portion 32 is the same as the distance between points (a) and (c). Consequently, in this embodiment, the bends in the second portion 32 are positioned and angled to provide a fold 36 which orients a part 38 of the second portion 32 substantially towards the first portion 30 and towards the ground point 28 at point (a).

In this embodiment, when distance d₁ is selected, electromagnetic coupling between the first portion 30 and the second portion 32 should be taken into account. When distance d₂ is selected, electromagnetic coupling between the part 38 and the part between points (c) and (d) of the second portion 32 should be taken into account. It will be appreciated by a person skilled in the art that the parasitic antenna 22 illustrated in FIG. 4 may have planar dimensions which are greater than the planar dimensions of the parasitic antennas illustrated in FIGS. 2 and 3 in order to reduce self electromagnetic coupling within the parasitic antenna 22.

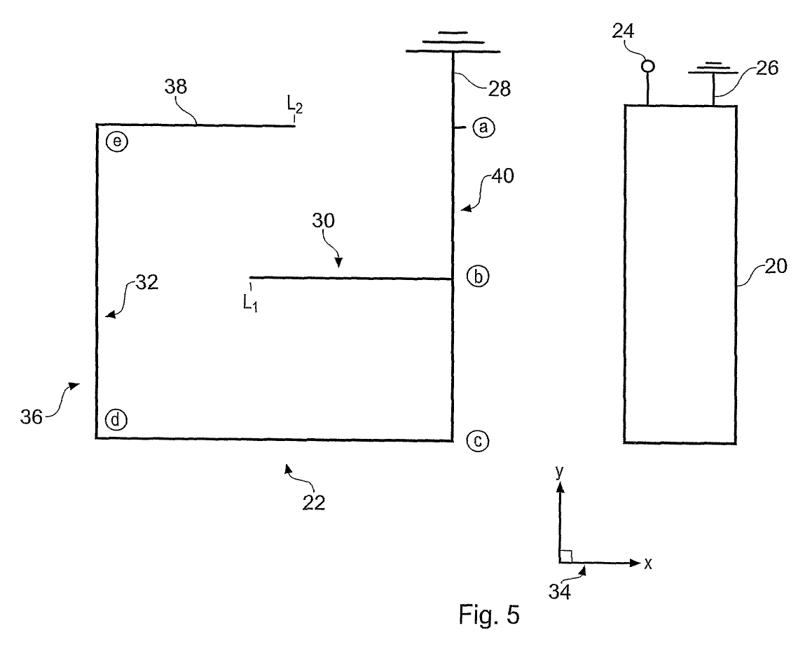

FIG. 5 illustrates a fourth embodiment of an antenna arrangement 14 which includes an antenna 20 and a parasitic antenna 22. As discussed above with reference to FIGS. 2 & 4, the antenna 20 may be any antenna which is suitable for an antenna arrangement within an apparatus such as a mobile cellular telephone etc. . . . For example, the antenna 20 may be a planar inverted F antenna (PIFA), an inverted F antenna (IFA), a monopole antenna or a loop antenna.

In this embodiment, a third portion 40 of the parasitic antenna 22 extends from the ground point 28 at point (a) in the −Y direction until point (b). At point (b), the first portion 30 extends in the −X direction until its end point. Also at point (b), the second portion 32 extends in the −Y direction until point (c) at which it makes a right-angled right hand bend. At point (c), the second portion 32 extends in the −X direction until point (d) where it makes a right-angled right handed bend and then extends in the +Y direction until point (e). At point (e), the second portion 32 (part 38) makes a right-angled right hand bend and extends in the +X direction until its end point. The above mentioned bends in the second portion 32 define a folded part 36 which orients the part 38 of the second portion 32 towards the first portion 30 and towards the ground point 28.

In this embodiment, the length L₁ of the first portion 30 includes the length of the third portion 40 (defined between points (a) and (b)). Similarly, the length L₂ of the second portion 32 includes the length of the third portion 40.

This embodiment provides an advantage in that the first portion 30 and the second portion 32 do not substantially magnetically couple with one another. This is because they are connected to the ground point 28 via the third portion 40. As mentioned above, the magnetic field of the parasitic antenna 22 is strongest near the ground point 28 and in this region the first portion 30 and the second portion 32 share the third portion 40. Consequently, since they share the third portion 40 where the magnetic field is at its strongest, they do not magnetically couple in that region.

Although embodiments of the present invention have been described in the preceding paragraphs with reference to various examples, it should be appreciated that modifications to the examples given can be made without departing from the scope of the invention as claimed. For example, the first portion 30 and the second portion 32 may have bends which are greater than and/or less than ninety degrees.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A parasitic antenna comprising:
a first portion having a first length;
a second portion having a second length, different to the first length; and
wherein the second portion includes a folded part which orients a part of the second portion substantially towards the first portion.

2. A parasitic antenna as claimed in claim 1, wherein the parasitic antenna is substantially planar and the folded part of the second portion is folded in the plane of the parasitic antenna.

3. A parasitic antenna as claimed in claim 2, wherein the folded part of the second portion includes a plurality of bends in the plane of the parasitic antenna.

4. A parasitic antenna as claimed in claim 3, wherein each bend of the plurality of bends is positioned and angled to determine a planar profile for the parasitic antenna.

5. A parasitic antenna as claimed in claim 4, wherein each bend of the plurality of bends is positioned and angled to reduce the planar dimensions of the parasitic antenna.

6. A parasitic antenna as claimed in claim 1, further comprising a ground point, wherein the folded part orients the part of the second portion towards the ground point.

7. A parasitic antenna as claimed in claim 6, wherein the first portion is connected to the ground point and the second portion is connected to the ground point, and the first portion and the second portion extend in substantially opposite directions from the ground point.

8. A parasitic antenna as claimed in claim 6, further comprising a third portion, connected to the ground point, the first portion and the second portion, wherein the first portion and the second portion are connected to the ground point via the third portion.

9. A parasitic antenna as claimed in claim 1, wherein the first portion is operable in a first frequency band and the second portion is operable in a second frequency band, different to the first frequency band.

10. A method comprising:
providing a first portion of a parasitic antenna having a first length, and
a second portion of the parasitic antenna having a second length, different to the first length; and arranging the second portion to include a folded part which orients a part of the second portion substantially towards the first portion.

11. A method as claimed in claim 10, wherein the parasitic antenna is substantially planar and the folded part of the second portion is folded in the plane of the parasitic antenna.

12. A method as claimed in claim 11, comprising arranging the folded part of the second portion to include a plurality of bends in the plane of the parasitic antenna.

13. A method as claimed in claim 12, comprising selecting the position and angle of each bend of the plurality of bends to determine a planar profile for the parasitic antenna.

14. (canceled)

15. A method as claimed in claim 10, further comprising providing a ground point, and arranging the folded part so that the part of the second portion is oriented towards the ground point.

16. (canceled)

17. (canceled)

18. A method as claimed in claim 10, wherein the first portion is operable in a first frequency band and the second portion is operable in a second frequency band, different to the first frequency band.

19. An antenna arrangement comprising a parasitic antenna as claimed in claim 1; and an antenna, connected to a feed point, which is arranged to electromagnetically couple with the parasitic antenna.

20. An apparatus comprising a parasitic antenna as claimed in claim 1.

21. An apparatus comprising an antenna arrangement as claimed in claim 19.

22. A parasitic antenna comprising:
a first portion having a first length;
a second portion having a second length, different to the first length, and a plurality of bends; and
wherein the parasitic antenna is substantially planar, and the plurality of bends are in the plane of the parasitic antenna and are positioned and angled to determine the planar profile of the parasitic antenna.

23. A parasitic antenna as claimed in claim 22, wherein the plurality of bends are positioned and angled to reduce the planar dimensions of the parasitic antenna.
